(19) United States
(12) Patent Application Publication
(10) Pub. No.: US 2024/0294727 A1
(43) Pub. Date: Sep. 5, 2024

(54) METHOD FOR THE CHEMICAL RECYCLING OF POLYETHYLENE FURANOATE (PEF), PUR/PIR HARD FOAM, AND PROCESS FOR MANUFACTURING PUR/PIR HARD FOAMS

(71) Applicant: puren GmbH, Überlingen (DE)

(72) Inventors: Thomas BOMMER, Überlingen (DE); Anton DEMHARTER, Hohenfels-Liggersdorf (DE)

(21) Appl. No.: 18/572,602

(22) PCT Filed: Jun. 15, 2022
(86) PCT No.: PCT/EP2022/066387

§ 371 Date: Dec. 20, 2023

(30) Foreign Application Priority Data
Jun. 21, 2021 (DE) 10 2021 115 988.1

(51) Int. Cl. C08J 11/24; C08J 9/14

(52) U.S. Cl. CPC C08J 11/24; C08J 9/141; C08J 2203/14; C08J 2205/10; C08J 2367/02

(57) ABSTRACT

A method for the chemical recycling of polyethylene furanoate (PEF), wherein a PEF polymer is converted into at least one low-molecular compound.

### CROSS-REFERENCE TO RELATED APPLICATIONS

This patent application is a U.S. national stage application of international patent application PCT/EP2022/066387, filed on Jun. 15, 2022, which is based on and claims priority to German patent application DE 10 2021 115 988.1, filed on Jun. 21, 2021, the contents of which are incorporated herein by reference.

### PRIOR ART

The invention relates to a method for the chemical recycling of polyethylene furanoate (PEF), to a PUR/PIR hard foam and to a process for manufacturing PUR/PIR hard foams.

Polyethylene furanoate (PEF) is a thermoplastic material which is manufactured from the starting materials 2,5-furandicarboxylic acid (FDCA) and ethylene glycol (MEG). The FDCA may be recovered from sustainable raw materials, for example by dehydrogenation of fructose and subsequent oxidation of the hydroxymethylfurfural recovered therefrom. If apart from the FDCA, the MEG is also synthesized from sustainable raw materials, PEF may be 100% biobased. PEF is characterized by high mechanical strength and good thermal properties and compared to the thermoplastic material polyethylene terephthalate (PET) has improved diffusion impermeability. PEF is therefore particularly suitable for manufacturing foodstuff packagings and drinks bottles and is considered in the longer term to be a possible biobased substitute for the petroleum-based PET. In particular in the area of drinks bottles and foodstuff packagings, large quantities of PEF waste streams, which are comparable with PET waste streams of today, can therefore be expected in the future. Since PEF is not biologically degradable, in the future the requirement to develop recycling technologies for PEF will appear in order to thus close the raw material circle. In this context it is currently known only that material recycling would be possible for PEF, wherein PEF could be comminuted and integrated into existing PET-recycling streams with a proportion of up to 5% without this having an effect on the properties of PET. However, as is well known even for valuable recycling of PET drinks bottles to form so-called regranulate, the problem arises that due to the high requirements of sorting purity of the regranulates and due to impurities of the PET waste streams, renewed manufacture of PET drinks bottles from PET regranulates is only possible with very high expense, for example by stripping off the uppermost layer of PET regranulates by means of hot sodium hydroxide solution to remove surface impurities and materials which have diffused in. However, such methods can be only rarely shown economically so that a large part of the PET regranulates recovered by means of material recycling is available only in low qualities which do not meet the requirements of purity in the foodstuffs industry. Such regranulates of lower quality may therefore only be used for further processing to lower-grade products, for example textile fibers. Such downcycling would therefore also be expected in the case of valuable recycling of PEF. However, in order to facilitate renewed processing to form particularly high-grade products, for example polyurethane (PUR) hard foams and/or polyisocyanurate (PIR) hard foams, from PEF waste streams, chemical recycling of PEF would be desirable. However, methods for the chemical recycling of PEF are currently not known from the prior art.

The object of the invention consists in particular in developing a method for the chemical recycling of polyethylene furanoate (PEF) and facilitating further processing of chemical compounds recovered therefrom to form high-grade products. The object is achieved according to the invention.

### Advantages of the Invention

A method for the chemical recycling of polyethylene furanoate (PEF) is proposed, wherein a PEF polymer is converted into at least one low-molecular compound.

Chemical recycling of polyethylene furanoate (PEF) may advantageously be facilitated by such a method. In particular a raw material circle of PEF may advantageously be closed. With respect to currently known methods for material recycling of PEF, conversion of PEF waste streams to particularly high-grade products in the chemical industry, for example to PUR/PIR hard foams, may advantageously be facilitated by means of the method for the chemical recycling of PEF of the invention. Use of petroleum-based starting materials in the chemical industry may thus advantageously be reduced, preferably minimized or completely replaced, whereby finite resources may be protected and emission of climate-damaging greenhouse gases, for example in the manufacture of PUR/PIR hard foams, may be reduced.

The PEF polymer used in the method preferably originates from a waste stream. The waste stream may comprise consumer wastes, such as PEF drinks bottles and/or other foodstuff packagings made of PEF and/or other products made of PEF, and/or production wastes, as accumulate in the manufacture of PEF and/or the manufacture of products made of PEF.

The method for the chemical recycling of polyethylene furanoate (PEF) comprises at least one method step in which the PEF polymer is converted into the at least one low-molecular compound. The conversion of the PEF polymer into the low-molecular compound could take place, for example, by means of pyrolysis. However, the conversion of the PEF polymer into the low-molecular compound preferably takes place by means of solvolysis. During the conversion of the PEF polymer, at least one further reaction product accumulates, in particular at least one polyhydric alcohol, for example ethylene glycol (MEG) and/or diethylene glycol (DEG). The method could comprise precisely one method step in which the PEF polymer is converted into the low-molecular compound and the low-molecular compound and/or the further reaction product is/are recovered as end product(s). The method is preferably multi-stage and comprises at least two method steps, wherein the PEF polymer is converted into the low-molecular compound in a first method step and in at least one subsequent further method step is converted into at least one further compound, in particular to a recycling polyol. The multi-stage method could be discontinuous. The multi-stage method is preferably continuous. The method may in addition comprise at least one pretreatment step. For example it is conceivable that the waste stream is first of all presorted in a pretreatment step and separated by suitable separating methods, for example by sink-swim sorting and/or air separation and/or magnetic separation and/or eddy current sorting and/or color sorting and/or near-infrared sorting and/or other suitable separating methods, from other waste materials, for example from other plastics, such as for example PET, PE, PP, PVC etc. and/or metals and/or paper and/or the like, and/or is separated from impurities, for example product residues. The PEF polymer is preferably in addition comminuted in the pretreatment step, for example ground, in particular in order to obtain as great as possible a surface for subsequent solvolysis.

The waste stream could contain, apart from the PEF polymer, in addition a proportion of at least one PET polymer. In this case, in the method the PEF polymer could be converted into the at least one low-molecular compound and the PET polymer into at least one further low-molecular compound, in particular without changes in the method management thus being necessary. Presorting of PEF and PET may thus advantageously be dispensed with. Due to the comparable chemical properties of PEF polymers and PET polymers, the waste stream could be composed in principle of any proportions of PEF polymers and PET polymers. In particular the waste stream has a predominant proportion of at least 50 wt. %, advantageously of at least 60 wt. %, particularly advantageously of at least 70 wt. %, preferably of at least 80 wt. % and particularly preferably of at least 90 wt. %, of PEF polymers.

The low-molecular compound and/or the further low-molecular compound has a molecular weight of at most 800 g/mol, advantageously at most 700 g/mol, preferably at most 600 g/mol and particularly preferably at most 500 g/mol. A degree of polymerization of the low-molecular compound and/or of the further low-molecular compound preferably corresponds at most to 50%, advantageously at most to 45%, particularly advantageously at most to 40%, preferably at most to 35% and particularly preferably at most to 30%, of a degree of polymerization of the PEF polymer used for the method. The low-molecular compound could be a monomer, specifically 2,5-furandicarboxylic acid (FDCA). In this case renewed manufacture of PEF, which could be further processed to form PEF drinks bottles, from the recovered FDCA and the MEG accumulating as a further reaction product, would be conceivable. The further low-molecular compound could be a further monomer, specifically terephthalic acid.

In an advantageous configuration of the method, it is proposed that the PEF polymer is converted into at least one oligomer, in particular a dimer or trimer, as the low-molecular compound. A low-molecular compound may thus advantageously be obtained which in a further method step may be converted particularly well to a recycling polyol which is suitable for manufacturing PUR/PIR hard foams. The oligomer could be, for example, a dimer or/a trimer or/a tetramer and/or a pentamer and/or a hexamer and/or a heptamer and/or an octamer and/or an oligomer with a degree of polymerization of greater than 8. The oligomer is particularly preferably a dimer or trimer. In the case that a proportion of PET polymer is in addition present in the waste stream, the PET polymer may be converted into at least one further oligomer, in particular a further trimer, as the further low-molecular compound. The further oligomer could be, for example, a dimer or/a trimer or/a tetramer and/or a pentamer and/or a hexamer and/or a heptamer and/or an octamer and/or an oligomer with a degree of polymerization of greater than 8. The further oligomer is particularly preferably a trimer.

In addition, it is proposed that the conversion of the PEF polymer into the low-molecular compound is carried out by means of a solvolysis. Due to such a configuration, a reliable method for the chemical recycling of PEF may advantageously be provided. Regarding solvolysis, the PEF polymer is added to a solvent or to a mixture of different solvents and stirred preferably for at least one hour. The solvent here partly diffuses into the structure of the PEF polymer, whereby the latter swells, wherein the solvent reacts with the ester bonds in the PEF polymer and conversion of the PEF polymer into the low-molecular compound takes place. Solvolysis could be hydrolysis, in particular acid hydrolysis or neutral hydrolysis or alkaline hydrolysis. It would also be conceivable that solvolysis is methanolysis using methane as the solvent. Solvolysis is preferably alcoholysis, wherein at least one, preferably polyhydric, alcohol is used as the solvent. For the case that a proportion of PET polymer is in addition present in the waste stream, conversion of the PET polymer into the further low-molecular compound may likewise be carried out by means of solvolysis.

In a particularly advantageous configuration, it is proposed that solvolysis is a glycolysis. A particularly reliable and technically easy-to-implement method for recycling PEF may thus advantageously be provided. For example ethylene glycol, and/or diethylene glycol and/or propylene glycol and/or dipropylene glycol and/or another suitable glycol could be used as the solvent in glycolysis. Diethylene glycol is preferably used as the solvent in glycolysis. It would also be conceivable that a mixture of ethylene glycol and diethylene glycol is used as the solvent in glycolysis.

Furthermore, it is proposed that the glycolysis is carried out at a temperature between 100° C. and 300° C. Reaction kinetics may thus advantageously be improved. In particular glycolysis is carried out at a temperature between 120° C. and 280° C., advantageously between 140° C. and 260° C., preferably between 160° C. and 250° C. and particularly preferably between 180° C. and 240° C. In particular the temperature at which glycolysis is carried out may be varied as a function of a degree of polymerization of the PEF polymer. Glycolysis preferably takes place, in particular for PEF polymers with a high degree of polymerization, at a temperature above 210° C., particularly preferably above 225° C., for example at a temperature between 230° C. and 235° C. For PEF polymers with a low degree of polymerization, temperatures below 205° C. are sufficient. Glycolysis may be carried out, for example, in a heatable stirred reactor. Glycolysis is preferably carried out for at least 30 minutes, particularly preferably for at least 60 minutes. Duration of glycolysis may be varied in particular depending on the desired degree of polymerization of the low-molecular compound to be obtained.

Furthermore, it is proposed that the low-molecular compound is converted into a recycling polyol by transesterification in the presence of at least one polyhydric alcohol, in particular diethylene glycol (DEG). A recycling polyol, which is suitable in particular for manufacturing PUR/PIR hard foams, may thus advantageously be manufactured using simple technical means. It may be useful, in particular as a function of the composition of the waste stream, that glycolysis is carried out only with some of the quantity of polyhydric alcohol required for transesterification and a remaining proportion of polyhydric alcohol is added only immediately before transesterification. In particular in the case of greatly varying compositions of waste streams which contain the PEF polymer, the required residual quantity of polyhydric alcohol after glycolysis may be calculated and added accordingly immediately before transesterification. The polyhydric alcohol could be, for example, ethylene glycol and/or diethylene glycol and/or propylene glycol and/or dipropylene glycol. The polyhydric alcohol is preferably diethylene glycol (DEG). Since polyethylene furanoate (PEF) consists of the starting materials 2,5-furandicarboxylic acid (FDCA) and ethylene glycol (MEG), the low-molecular compound available by means of the method of the invention, in particular the dimer or trimer, also has sub-units which consist of FDCA and MEG, so that by transesterification in the presence of diethylene glycol (DEG), a recycling polyol with sub-groups consisting of FDCA and MEG may be obtained which has end groups consisting of DEG. Such a recycling polyol with end groups consisting of DEG is characterized by its particularly advantageous properties with regard to the manufacture of PUR/PIR hard foams which differ only insignificantly from the advantageous properties of polyols for PUR/PIR hard foam manufacture which synthesized directly from FDCA and DEG and are characterized by viscosities between 4,000 mPas and 5,500 mPas and associated good processability in PUR/PIR hard foam manufacture. Transesterification is preferably carried out under pressure conditions which are reduced with respect to atmospheric pressure, in particular under partial vacuum, in particular in a pressure range between 750 mbar and 0.1 mbar, wherein the pressure may be varied in particular during the process. Transesterification may be carried out, for example, in a heatable stirred reactor with attached rectification column. For the case that a proportion of PET polymer is in addition present in the waste stream, the further low-molecular compound may be converted during transesterification to a further recycling polyol, in particular without changes in the method management thus being necessary.

In a particularly advantageous configuration, it is proposed that an equivalent concentration of polyhydric alcohol to the PEF polymer is selected for transesterification so that the resulting recycling polyol has an OH number less than 400 mg KOH/g. Due to such a configuration, a recycling polyol with particularly advantageous properties for the manufacture of PUR/PIR hard foams may be obtained. The equivalent concentration of the polyhydric alcohol is related here to the molar mass of the repeating unit of the PEF polymer of 182 g/mol in the starting concentration before transesterification. For example it would be conceivable that the polyhydric alcohol is presented in an equivalent concentration between 0.5 and 2.00, preferably between 0.75 and 1.00 relative to starting concentration of the PEF polymer before transesterification.

Further, it is proposed that ethylene glycol released during the transesterification is at least partly distilled off. A recycling polyol with a low content of free glycol and therefore particularly advantageous properties for the manufacture of PUR/PIR hard foams may thus advantageously be obtained. Ethylene glycol released during transesterification is preferably distilled off completely. Furthermore, it is conceivable that after transesterification, free diethylene glycol (DEG) is also in addition distilled off. Distilling-off of free DEG is preferably carried out at a pressure less than 2 mbar, particularly preferably less than 1 mbar. The OH number of the recycling polyol may thus advantageously be set to desired values, in particular between 150 mg KOH/g and 400 mg KOH/g.

In addition, it is proposed that at least one catalyst is used for the transesterification. Reaction kinetics may thus advantageously be further improved. The catalyst could be, without being restricted thereto, zeolites and/or ionic liquids and/or metal compounds, for example tetrabutyl titanate, cobalt acetate, manganese acetate or zinc oxide.

The invention further relates to a recycling polyol which is obtainable by a method for the chemical recycling of PEF described above. A recycling polyol available by means of the method of the invention is characterized on the one hand in particular by its advantageous properties with regard to sustainability and on the other hand in particular by its properties for manufacturing PUR/PIR hard foams which are comparable with traditional polyols synthesized from petroleum-based starting materials or even improved. In particular the polyol available by means of the method of the invention has comparable or improved properties with regard to expandability to form PUR/PIR hard foams. To process the recycling polyol of the invention to form PUR/PIR hard foams, therefore no noticeable changes in the formula and the process engineering of the foaming plants and/or those exceeding the conventional extent are necessary so that advantageously PUR/PIR hard foams conforming to standards may be provided with usual or improved quality, wherein at the same time sustainability with respect to traditional PUR/PIR hard foams is significantly improved. Due to the manufacture of the recycling polyol from a PEF polymer, the polyol of the invention would be easy for a person skilled in the art to differentiate from traditional polyols for manufacturing PUR/PIR hard foams known currently from the prior art by means of suitable measuring methods, for example by means of nuclear magnetic resonance spectroscopy (H1-NMR).

In a particularly advantageous configuration, it is proposed that the recycling polyol has the following generalized structure:

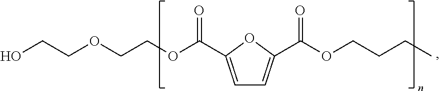

wherein n may in particular assume positive values between 1.0 and 10.0. A recycling polyol may thus advantageously be provided which is suitable in particular for manufacturing PUR/PIR hard foams, since it has properties comparable with currently commercially available polyols based on fossil raw materials or even improved. In the above-mentioned generalized structural formula of the recycling polyol, n may assume in particular positive values between 1.0 and 10.0, advantageously between 1.0 and 7.0, particularly advantageously between 1.0 and 5.0, preferably between 1.0 and 4.0, preferably between 2.0 and 4.0. Particularly preferably n has a value between 2.0 and 3.0. In principle positive values greater than 10.0 are also conceivable for n. In the present case, the indicated value ranges of n relate to macromolecules of the recycling polyol and are therefore statistical average values.

Further, the invention starts from a PUR/PIR hard foam manufactured from at least one polyol.

It is proposed that the polyol is at least partly a recycling polyol which is recycled from polyethylene furanoate (PEF), in particular according to a method for the chemical recycling of PEF described above. Due to such a configuration, a PUR/PIR hard foam with improved properties with regard to sustainability may advantageously be provided. In particular use of petroleum-based starting materials may advantageously be reduced, preferably minimized or completely replaced, whereby finite resources may be protected and emission of climate-damaging greenhouse gases may be reduced in the manufacture of PUR/PIR hard foams. The PUR/PIR hard foam of the invention is characterized, apart from its significantly improved properties with regard to sustainability, in particular also by its advantageous technical properties, in particular with regard to low thermal conductivity and low fire performance which are comparable to traditional PUR/PIR hard foams or even exceed the latter.

The fact that the polyol is “at least partly” a recycling polyol should be understood to mean that the recycling polyol accounts for at least 10 wt. %, in particular at least 20 wt. %, advantageously at least 30 wt. %, particularly advantageously at least 40 wt. %, preferably at least 50 wt. % and particularly preferably at least 60 wt. %, of the total mass of polyol from which the PUR/PIR hard foam is manufactured.

In addition, it is conceivable that the polyol is at least partly a further recycling polyol, which is recycled from polyethylene terephthalate (PET) and which accumulates in particular as a byproduct in a method for the chemical recycling of PEF described above.

In a particularly advantageous configuration, it is proposed that the polyol is predominantly a recycling polyol which is recycled from polyethylene furanoate (PEF). Due to such a configuration, sustainability of the PUR/PIR hard foam may advantageously be improved still further. By the polyol being “predominantly” a recycling polyol is to be understood that the recycling polyol accounts for at least 50 wt. %, in particular at least 60 wt. %, advantageously at least 70 wt. %, particularly advantageously at least 80 wt. %, preferably at least 90 wt. % and particularly preferably at least 95 wt. %, of the total mass of polyol from which PUR/PIR hard foam is manufactured.

In an alternative advantageous configuration, it is proposed that the polyol is at least partly a recycling polyol, which is recycled from polyethylene furanoate (PEF), and at least partly a further polyol which is manufactured predominantly from sustainable raw materials. Due to such a configuration, a PUR/PIR hard foam with improved properties with regard to sustainability may advantageously be provided. The further polyol is preferably synthesized from a polyhydric alcohol and an aromatic dicarboxylic acid which is manufactured predominantly from sustainable raw materials. The aromatic dicarboxylic acid is preferably 2,5-furandicarboxylic acid which is manufactured predominantly from sustainable raw materials. The aromatic dicarboxylic acid, in particular the 2,5-furandicarboxylic acid, is manufactured from sustainable raw materials with a predominant proportion of greater than 50 wt. %, in particular of greater than 60 wt. %, advantageously of greater than 70 wt. %, particularly advantageously of greater than 80 wt. %, preferably of greater than 90 wt. %, and particularly preferably with a proportion of 95 wt. % up to and including 100 wt. %. The 2,5-furandicarboxylic acid may be manufactured at least predominantly from sustainable raw materials, for example by dehydrogenation of hexoses, in particular fructose, which may be recovered, for example from sugar beets or sugar cane, and subsequent oxidation of the hydroxymethylfurfural (5-HMF) recovered therefrom. Further, manufacture of 2,5-furandicarboxylic acid is also conceivable from wastes from agriculture and/or the food-processing industry, for example from stale goods, from which hydroxymethylfurfural (5-HMF) may be recovered by means of hydrothermal treatment and subsequent extraction from an aqueous solution as starting material for the 2,5-furandicarboxylic acid. In addition, manufacture of 2,5-furandicarboxylic acid from inulin-accumulating plants, for example from inulin-containing chicory root fibers, which accumulate as agricultural waste, is conceivable, wherein first of all inulin is extracted, converted by means of hydrothermal dehydration to form hydroxymethylfurfural (5-HMF) and then oxidized biocatalytically or by heterogenous catalysis to form 2,5-furandicarboxylic acid (FDCA). Sustainable raw materials within the scope of the present application are exclusively organic raw materials which are not of fossil origin. Sustainable raw materials are preferably in the present case native products from agricultural and/or forestry production and byproducts thereof and/or residual materials provided they are not subject to waste legislation, and algae. The polyhydric alcohol for the synthesis of the polyol is advantageously a dihydric alcohol, in particular ethylene glycol (MEG), preferably diethylene glycol (DEG). Alternatively however, use of trihydric, tetrahydric or polyhydric alcohols would also be conceivable in principle. The polyhydric alcohol could be manufactured synthetically. Both the aromatic dicarboxylic acid and the polyhydric alcohol are particularly preferably manufactured at least predominantly from sustainable raw materials.

Furthermore, it is proposed that the recycling polyol has an OH number between 150 mg KOH/g and 400 mg KOH/g. The recycling polyol preferably has an OH number between 200 mg KOH/g and 350 mg KOH/g. A PUR/PIR hard foam with a high crosslinking density and hence good dimensional stability desirable for many applications and high pressure loadability may thus advantageously be provided.

Further, it is proposed that the recycling polyol has an average molar mass less than 1,000 g/mol. The recycling polyol advantageously has an average molar mass or an average molecular weight between 400 g/mol and 900 g/mol, preferably between 600 g/mol and 850 g/mol. The recycling polyol particularly preferably has an average molar mass of less than 700 g/mol. A PUR/PUR hard foam with a low specific gravity (SG) may thus advantageously be provided. The average molar mass of the polyol can be determined, for example by means of nuclear magnetic resonance spectroscopy (H1-NMR).

In addition, it is proposed that the recycling polyol has a content of free glycol of less than 20 wt. % relative to its total mass. A PUR/PIR hard foam with advantageous technical properties may thus be provided. In particular the recycling polyol has a content of free glycol of less than 18 wt. %, advantageously less than 15 wt. %, particularly preferably less than 12 wt. %, preferably less than 10 wt. % and particularly preferably less than 8 wt. %. The recycling polyol may have a content of free glycol of greater than or equal to 6 wt. %.

Furthermore, it is proposed that the recycling polyol has a dynamic viscosity between 3,000 mPas and 12,000 mPas. Improved processability of the recycling polyol and hence a PUR/PIR hard foam with improved properties with regard to ability for manufacture may thus advantageously be provided. In particular the recycling polyol has a dynamic viscosity between 4,000 mPas and 8,000 mPas, advantageously between 4,000 mPas and 7,000 mPas, particularly advantageously between 4,000 mPas and 6,000 mPas, preferably between 4,000 mPas and 5,500 mPas and particularly preferably between 4,000 mPas and 5,000 mPas. The indicated dynamic viscosities here relate to measurements according to the standard DIN EN ISO 3219.

Furthermore, it is proposed that the PUR/PIR hard foam has a thermal conductivity between 0.018 W/(mK) and 0.021 W/(mK). A PUR/PIR hard foam with improved properties with regard to heat insulation may thus advantageously be provided. The PUR/PIR hard foam preferably has a thermal conductivity between 0.018 W/(mK) and 0.020 W/(mK). The thermal conductivity of the PUR/PIR hard foam in the range between 0.018 W/(mK) and 0.021 W/(mK) is a measured value measured immediately after manufacture. Traditional PUR/PIR hard foams with particularly good heat insulation, which are manufactured on the basis of petroleum-based polyols, a polyisocyanate and the foaming agent pentane, in the best case have thermal conductivities measured immediately after their manufacture in the range between 0.020 W/(mK) and 0.021 W/(mK). It is known that PEF has improved diffusion impermeability compared to the plastic polyethylene terephthalate (PET), wherein an 02 barrier of PEF is up to six times greater with respect to PET, a CO2 barrier of PEF is up to three times greater with respect to PET and an H2O barrier of PEF is up to two times greater with respect to PET. Since recycling polyol for manufacturing the PUR/PIR hard foam of the invention is recycled from PEF and accounts for a proportion of the PUR/PIR hard foam of at least 25 wt. %, preferably at least 30 wt. %, of the total mass, it may be assumed that the very good barrier properties of the PEF with respect to 02, CO2 and H2O according to the proportion of the recycling polyol can also be transferred proportionally to the PUR/PIR hard foam of the invention. It is therefore assumed that the thermal conductivity of the PUR/PIR hard foam of the invention is thus reduced by at least 5% with respect to traditional PUR/PIR hard foams expanded by means of pentane so that thermal conductivities between 0.018 W/(mK) and 0.021 W/(mK), preferably between 0.019 W/(mK) and 0.020 W/(mK), are achieved.

In addition, the invention relates to a process for manufacturing PUR/PIR hard foams, in particular according to one of the configurations described above, wherein at least one polyisocyanate, at least one recycling polyol, which is recycled from polyethylene furanoate (PEF), in particular according to a method for the chemical recycling of PEF described above, and at least one foaming agent, are converted into a PUR/PIR hard foam. Such a method may advantageously achieve a particularly sustainable manufacture of PUR/PIR hard foams. The polyisocyanate may be, without being restricted thereto, for example polymeric diphenylmethane diisocyanate (PMDI) and/or methylene diphenyl isocyanate (MDI) and/or hexamethylene diisocyanate (HDI) and/or toluene diisocyanate (TDI) and/or naphthalene diisocyanate (NDI) and/or isophorone diisocyanate (IPDI) and/or 4,4′-diisocyanato dicyclohexylmethane (H12MDI). The polyisocyanate is preferably polymeric diphenylmethane diisocyanate (PMDI). The foaming agent is preferably pentane. Alternatively or in addition, CO2, which is produced on addition of water by reaction with the isocyanate component, and/or partly fluorinated hydrocarbons, for example HFC-365mfc and HFC-245fa, would also be conceivable in principle as foaming agent. In addition, further additives, in particular flame retardants and/or activators, and/or emulsifiers and/or foam stabilizers and/or further additives which appear useful to the person skilled in the art, may be used in the method. In addition, use of catalysts in the method is conceivable. Polyurethanes are produced in the method by a polyaddition reaction of the polyisocyanate with the polyol. By using polyisocyanate in excess, linear polyurethanes may be crosslinked. By addition of an isocyanate group to a urethane group, an allophanate group is formed. By trimerization of three isocyanate groups, the formation of an isocyanurate group is also possible. If polyfunctional polyisocyanates are used, highly branched polyisocyanurates (PIR) are formed so that PIR hard foams may be recovered.

Additionally, it is proposed that in addition to the recycling polyol, at least one further recycling polyol, which is recycled from polyethylene terephthalate (PET), is converted into the PUR/PIR hard foam. A particularly flexible process may thus advantageously be provided. In the process for manufacturing PUR/PIR hard foams, the further recycling polyol, which may accumulate as a byproduct in the method for the chemical recycling of PEF described above, is preferably converted into the PUR/PIR hard foam in addition to the recycling polyol. Due to the comparable chemical properties of the recycling polyol, which is recycled from PEF, and of the further recycling polyol, which is recycled from PET, PUR/PIR hard foams with equivalent properties with respect to PUR/PIR hard foams manufactured exclusively from the recycling polyol, may advantageously be obtained. Alternatively or in addition, it would also be conceivable that the further recycling polyol originates from a separate method for the chemical recycling of PET. A ratio between the recycling polyol used in the process and the further recycling polyol can be freely selected in principle. In particular a total mass of recycling polyols used in the process is composed to a predominant proportion of at least 50 wt. %, advantageously of at least 60 wt. %, particularly advantageously of at least 70 wt. %, preferably of at least 80 wt. %, of the recycling polyol which is recycled from polyethylene furanoate (PEF).

Further advantages and further embodiments of the present invention are seen from the following description of the exemplary embodiments and from the claims. The person skilled in the art will expediently also consider the features mentioned herein individually and summarize them to form useful further combinations. It goes without saying here that the features of the invention mentioned above and those explained below can be used not only in the respectively indicated combination, but also in other combinations without leaving the framework of the invention described above and below. In particular the combination of at least one preferred feature with at least one particularly preferred feature, or the combination of at least one feature not characterized further with at least one preferred and/or particularly preferred feature is also implicitly included, even if such combinations are not expressly mentioned.

### DESCRIPTION OF THE EXEMPLARY EMBODIMENTS

Illustrative embodiments of the present invention are listed below, wherein they do not restrict the present invention.

First of all generally a method for the recycling of polyethylene furanoate (PEF) and a process for manufacturing PUR/PIR hard foams are described below before the individual exemplary embodiments are discussed in detail.

In the method for the recycling of PEF, a PEF polymer is converted into at least one low-molecular compound. In the present case, the PEF polymer is converted into at least one oligomer as the low-molecular compound. Conversion of the PEF polymer into the low-molecular compound is carried out by means of solvolysis. In the present case, solvolysis is glycolysis. Glycolysis is carried out at a temperature between 100° C. and 300° C. specifically in a heatable stirred reactor. The low-molecular compound thus obtained is then converted into a recycling polyol by transesterification in the presence of a polyhydric alcohol, preferably diethylene glycol (DEG). In the present case, an equivalent concentration of polyhydric alcohol to the low-molecular compound is selected for transesterification so that the resulting recycling polyol has an OH number less than 400 mg KOH/g. Ethylene glycol, which is released during transesterification, is at least partly, in the present case completely, distilled off. At least one catalyst is used during transesterification.

A recycling polyol available according to the method for the recycling of PEF has an OH number between 150 mg KOH/g and 400 mg KOH/g. The recycling polyol has an average molar mass less than 1,000 g/mol. The recycling polyol has a content of free glycol of less than 20 wt. % relative to its total mass. The recycling polyol has a dynamic viscosity between 3,000 mPas and 12,000 mPas. The recycling polyol has the following generalized structure:

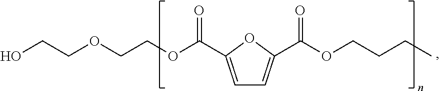

wherein n may assume in particular positive values between 1.0 and 10.0. In the present case, n has values between 2.0 and 3.0, in particular in order to achieve the previously mentioned dynamic viscosities and associated good processability in the manufacture of PUR/PIR hard foams.

The recycling polyol is then used in a process for manufacturing PUR/PIR hard foams.

In the process for manufacturing PUR/PIR hard foams, at least one polyisocyanate, at least one polyol, specifically at least the recycling polyol, which is recycled from polyethylene furanoate (PEF), and at least one foaming agent are converted into a PUR/PIR hard foam.

In a configuration of the process for manufacturing PUR/PIR hard foams, at least one polyisocyanate, the recycling polyol, which is recycled from polyethylene furanoate (PEF), in addition at least one further recycling polyol, which is recycled from polyethylene terephthalate (PET), and at least one foaming agent are converted into a PUR/PIR hard foam. A PUR/PIR hard foam manufactured by means of this configuration of the process is manufactured from at least one polyol, wherein the polyol is at least partly a recycling polyol which is recycled from polyethylene furanoate (PEF). In particular the polyol is predominantly the recycling polyol which is recycled from polyethylene furanoate (PEF). The PUR/PIR hard foam thus obtainable has a thermal conductivity between 0.018 W/(mK) and 0.021 W/(mK).

In an alternative configuration of the process for manufacturing PUR/PIR hard foams, at least one polyisocyanate, the recycling polyol, which is recycled from polyethylene furanoate (PEF), at least one further polyol and at least one foaming agent are converted into a PUR/PIR hard foam. In the present case, the further polyol is a polyol which is manufactured predominantly from sustainable raw materials.

A PUR/PIR hard foam manufactured by means of this configuration of the process is manufactured from at least one polyol, wherein the polyol is at least partly a recycling polyol, which is recycled from polyethylene furanoate (PEF), and at least partly a polyol which is manufactured predominantly from sustainable raw materials. The PUR/PIR hard foam has a thermal conductivity between 0.018 W/(mK) and 0.021 W/(mK).

### Exemplary Embodiment 1

In a method for the chemical recycling of polyethylene furanoate (PEF) according to Exemplary Embodiment 1, a PEF polymer is converted into at least one low-molecular compound. The method is discontinuous and is carried out in several method steps. In a first method step 3,700 g of diethylene glycol (DEG) are thus added to a heatable stirred reactor with a holding volume of 6 liters and preheated to 240° C. 990 g of PEF polymer and 10 g of PET polymer are then added and dissolved in the diethylene glycol by stirring the reaction mixture for 150 minutes. The PEF polymer is converted here by means of glycolysis to a low-molecular compound and the PET polymer is converted into a further low-molecular compound. The low-molecular compound is predominantly oligormers, specifically trimers which are composed of three acid groups of 2,5-furandicarboxylic acid. The further low-molecular compound is predominantly oligomers, specifically trimers which are composed of three acid groups of terephthalic acid. In a further method step of the method, the reaction mixture is cooled to 180° C. and separated from residues and impurities present as solids by filtration over a suction filter designed with filter paper. The filtrate obtained is then transferred to a further heatable stirred reactor with a holding volume of 6 liters. The further stirred reactor is operated with an attached rectification column which is equipped with 10 bubble-cap plates and a heatable outer jacket. 150 mg of tetrabutyl titanate are added as transesterification catalyst. The reaction mixture is heated at a pressure of 680 mbar. Transesterification starts after reaching a temperature of 225° C., wherein the low-molecular compound is converted into a recycling polyol and the further low-molecular compound is converted into a further recycling polyol. During transesterification, accumulating ethylene glycol (EG) is distilled off continuously. By setting the column jacket temperature to 180° C. and regulating the head temperature by varying the reflux ratio to likewise 180° C., the EG distilling off is largely separated off from DEG. The temperature is increased with the quantity of EG distilled off and at the end of the process is 235° C. for a head temperature reduced to 175° C. The transesterification product has an OH number of 728 mg KOH/g. The transesterification product is then cooled to 130° C. and by gradual increase of the vacuum, the free DEG is distilled off while avoiding the column. The pressure at the end of the distillation process is 0.2 mbar, the temperature of the product 130° C. A recycling polyol with an OH number of 305 mg KOH/g and a dynamic viscosity of 3,500 mPas is obtained.

A PUR/PIR hard foam is then manufactured from the recycling polyol obtained by means of the method for the chemical recycling of PEF and the further recycling polyol by means of a process for manufacturing PUR/PIR hard foams together with methylene diphenyl isocyanate (MDI) as the polyisocyanate and pentane as the foaming agent. The PUR/PIR hard foam manufactured by means of this process has a bulk density of 30.2 kg/m3. A measured thermal conductivity of the PUR/PIR hard foam is 0.0209 W/(mK), the measured value was ascertained at 23° C. average temperature on the laboratory foam. System foams, measured at 10° C. average temperature, have thermal conductivities lower by about 0.002 to 0.003 W/(mK). The fire performance of the PUR/PIR hard foam manufactured corresponds to Building Material Class E according to DIN EN ISO 11925-2.

### Exexmplary Embodiment 2

In a method for the chemical recycling of polyethylene furanoate (PEF) according to Exemplary Embodiment 2, a PEF polymer is converted into at least one low-molecular compound. In a first method step 858 g of diethylene glycol (DEG) are thus added to a heatable stirred reactor with a holding volume of 6 liters and preheated to 240° C. A rectification column with 10 bubble-cap plates and a heatable outer jacket is attached to the stirred reactor. 1,820 g of PEF polymer are then added and dissolved in the diethylene glycol by stirring the reaction mixture for 150 minutes. The reaction mixture is then cooled to 180° C. and 200 mg of tetrabutyl titanate are added as transesterification catalyst. An equivalent concentration of DEG to the PEF polymer is selected for transesterification so that a resulting recycling polyol has an OH number less than 400 mg KOH/g. In the present case, the equivalent concentration of DEG is 0.81.

The reaction mixture is heated again at a pressure of 680 mbar. Transesterification starts after reaching a temperature of 225° C., wherein the low-molecular compound is converted into a recycling polyol. During transesterification, accumulating ethylene glycol (EG) is distilled off continuously. By setting the column jacket temperature to 180° C. and regulating the head temperature by varying the reflux ratio to likewise 180° C., the EG distilling off is largely separated off from DEG. The temperature is increased with the quantity of EG distilled off and at the end of the process is 235° C. for a head temperature reduced to 175° C.

The product is then cooled to 130° C. and by gradual increase of the vacuum, the free DEG is distilled off while avoiding the column. The pressure at the end of the distillation process is 0.2 mbar, the temperature of the product 130° C.

A recycling polyol with an OH number of 288 mg KOH/g and a dynamic viscosity between 3,000 mPas and 12,000 mPas, in the present case between 4,000 mPas and 8,000 mPas, is obtained.

A PUR/PIR hard foam is then manufactured from the recycling polyol obtained by means of the method for the chemical recycling of PEF by means of a process for manufacturing PUR/PIR hard foams together with methylene diphenyl isocyanate (MDI) as the polyisocyanate and pentane as the foaming agent. In the process, a mixture of the recycling polyol and a polyol, which is manufactured predominantly from sustainable raw materials, is used, wherein both polyols are mixed in the ratio 1 to 1. The polyol, which is manufactured predominantly from sustainable raw materials, is a polyol which is synthesized from 2,5-furandicarboxylic acid, which is manufactured at least substantially from sustainable raw materials, and diethylene glycol. The polyol manufactured predominantly from sustainable raw materials and the recycling polyol therefore have a very similar chemical structure and comparable properties.

The PUR/PIR hard foam manufactured by means of this process has a thermal conductivity between 0.018 W/(mK) and 0.021 W/(mK).

1. A method for the chemical recycling of polyethylene furanoate (PEF), wherein a PEF polymer is converted into at least one low-molecular compound.

2. The method as claimed in claim 1, wherein the PEF polymer is converted into at least one oligomer, in particular a dimer or trimer, as the low-molecular compound.

3. The method as claimed in claim 1, wherein the conversion of the PEF polymer into the low-molecular compound is carried out by means of a solvolysis.

4. The method as claimed in claim 3, wherein the solvolysis is a glycolysis.

5. The method as claimed in claim 4, wherein the glycolysis is carried out at a temperature between 100° C. and 300° C.

6. The method as claimed in claim 4, wherein the low-molecular compound is converted into a recycling polyol by transesterification in the presence of at least one polyhydric alcohol, in particular diethylene glycol (DEG).

7. The method as claimed in claim 6, wherein an equivalent concentration of polyhydric alcohol to the PEF polymer is selected for transesterification so that the resulting recycling polyol has an OH number less than 400 mg KOH/g.

8. The method as claimed in claim 6, wherein ethylene glycol released during the transesterification is at least partly distilled off.

9. The method as claimed in claim 6, wherein at least one catalyst is used for the transesterification.

10. A recycling polyol obtainable by a method as claimed in claim 6.

11. The recycling polyol as claimed in claim 10, wherein the recycling polyol has the following generalized structure: 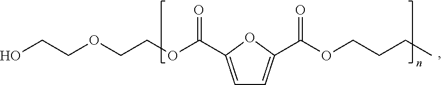
wherein n may in particular assume positive values between 1.0 and 10.00.

12. A PUR/PIR hard foam manufactured from at least one polyol, wherein the polyol is at least partly a recycling polyol which is recycled from polyethylene furanoate (PEF).

13. The PUR/PIR hard foam as claimed in claim 12, wherein the polyol is predominantly a recycling polyol which is recycled from polyethylene furanoate (PEF).

14. The PUR/PIR hard foam as claimed in claim 12, wherein the polyol is at least partly a recycling polyol which is recycled from polyethylene furanoate (PEF), and at least partly a polyol which is manufactured predominantly from sustainable raw materials.

15. The PUR/PIR hard foam as claimed in claim 12, wherein the recycling polyol has an OH number between 150 mg KOH/g and 400 mg KOH/g.

16. The PUR/PIR hard foam as claimed in claim 12, wherein the recycling polyol has an average molar mass less than 1,000 g/mol.

17. The PUR/PIR hard foam as claimed in claim 12, wherein the recycling polyol has a content of free glycol of less than 20 wt. % relative to its total mass.

18. The PUR/PIR hard foam as claimed in claim 12, wherein the recycling polyol has a dynamic viscosity between 3,000 mPas and 12,000 mPas.

19. The PUR/PIR hard foam as claimed in claim 12, having a thermal conductivity between 0.018 W/(mK) and 0.021 W/(mK).

20. A process for manufacturing PUR/PIR hard foams, in particular as claimed in claim 12, wherein at least one polyisocyanate, at least one recycling polyol, which is recycled from polyethylene furanoate (PEF), and at least one foaming agent, are converted into a PUR/PIR hard foam.

21. The process as claimed in claim 20, wherein in addition to the recycling polyol, at least one further recycling polyol, which is recycled from polyethylene terephthalate (PET), is converted into the PUR/PIR hard foam.
